(19) United States
(12) Patent Application Publication
(10) Pub. No.: US 2026/0010777 A1
(43) Pub. Date: Jan. 8, 2026

(54) GENERATION METHOD, APPLICATION METHOD, TRAINING APPARATUS AND APPLICATION APPARATUS FOR NEURAL NETWORK MODEL, STORAGE MEDIUM

(71) Applicant: CANON KABUSHIKI KAISHA, Tokyo (JP)

(72) Inventors: Lingxiao Yin, Beijing (CN); Wei Tao, Beijing (CN); Tsewei Chen, Tokyo (JP); Dongyue Zhao, Beijing (CN)

(21) Appl. No.: 19/259,838

(22) Filed: Jul. 3, 2025

(30) Foreign Application Priority Data
Jul. 5, 2024 (CN) 202410897980.3

(51) Int. Cl. G06N 3/0495; G06N 3/0455

(52) U.S. Cl. CPC G06N 3/0495; G06N 3/0455

(57) ABSTRACT

The present disclosure provides a generation method, an application method, a training apparatus and an application apparatus for a neural network model, a storage medium, and a computer program product. The generation method comprises: compressing feature maps generated in an encoding stage of a U-shaped neural network model or a variant thereof, wherein the feature maps are connected to a decoding stage of the U-shaped neural network model or the variant thereof via skip connections, wherein the U-shaped neural network model or the variant thereof includes at least an encoding stage and the decoding stage for processing image data; compressing, in the encoding stage, the generated feature map to be connected to the decoding stage; and generating, in the decoding stage, enhanced feature maps from the compressed feature maps.

### CROSS REFERENCE TO RELATED APPLICATIONS

This application claims the benefit of Chinese Patent Application No. 202410897980.3, filed Jul. 5, 2024, which is hereby incorporated by reference herein in its entirety.

### TECHNICAL FIELD

The present disclosure relates to the field of modeling of Deep Neural Network (DNN) models.

### BACKGROUND

A U-Net (U-shaped neural network) models has become a benchmark network model in a pixel-level computer vision study. Its network structure mainly includes three parts: an encoding stage, a decoding stage, and skip connection structures between them. The skip connections pass feature map information generated in the encoding stage to the decoding stage. The network structure in the encoding stage usually includes multilayer downsampling operations, wherein resolutions of the output feature maps of the downsampling operations are smaller than resolutions of the input feature maps. This will result in a loss of some detailed information in the input feature maps. After the input image undergoes all the downsampling operations in the encoding stage, the feature maps generated in the decoding stage will lose a significant amount of meaningful detailed information. The skip connections can compensate for these detailed information while incurring nearly no additional computational burden.

The feature maps passed via the skip connections when the network is derived forward require a substantial amount of storage space. This storage space is allocated during the encoding stage, and is released stepwise until the decoding stage. The size of this storage space allocated for the input feature maps of the skip connections even exceeds a storage space allocated for the input feature maps and output feature maps of certain network layers during a neural network inference. Such characteristic poses a bottleneck in the U-Net model during hardware deployment with limited resources.

As shown in the disclosed typical U-Net structure shown in FIG. 11A, the encoding process of the network comprises five stages which output feature maps {E1, E2, E3, E4, E5} respectively. Resolutions of these feature maps decreases sequentially with resolutions of adjacent feature maps being halved, while number of channels is doubled. The decoding process also comprises five stages which output feature maps {D1, D2, D3, D4, D5} respectively. Resolutions of these feature maps increases sequentially with resolutions of adjacent feature maps being doubled, while number of channels is halved. In this network, there are four skip connections connecting E1 and D1, connecting E2 and D2, connecting E3 and D3, connecting E4 and D4 respectively. A memory size relating to the skip connections which records all those needed to be saved is M_{sc}. At the end of the E1 stage, the memory size needed to be occupied by the generated feature maps is M_{E1}=C*H*W, wherein C represents the number of channels of the feature maps, and H and W represent the height and width of the feature maps respectively; at this time, M_{sc}=M_{E1}. At the end of the E2 stage, the memory size needed to be occupied by the generated feature maps is

$${M}_{E 2} = 2 * C * \frac{H}{2} * \frac{W}{2} = \frac{1}{2} {M}_{E 1} ;$$

at this time,

$${M}_{s c} = {M}_{E 1} + {M}_{E 2} = \frac{3}{2} * {M}_{E 1} .$$

Similarly, at the end of the E3 stage,

$${M}_{E 3} = 4 * C * \frac{H}{4} * \frac{W}{4} = \frac{1}{4} {M}_{E 1} ;$$

at this time,

$${M}_{s c} = {M}_{E 1} + {M}_{E 2} + {M}_{E 3} = \frac{7}{4} * {M}_{E 1} .$$

At the end of the E4 stage,

$${M}_{E 4} = 8 * C * \frac{H}{8} * \frac{W}{8} = \frac{1}{8} {M}_{E 1} ;$$

at this time,

$${M}_{s c} = {M}_{E 1} + {M}_{E 2} + {M}_{E 3} + {M}_{E 4} = \frac{15}{8} * {M}_{E 1} ,$$

which reaches the memory peak. At the end of the D4 stage, M_{E4} corresponding to E4 is released; at this time, M_{sc}=M_{E1}+M_{E2}+M_{E3}. At the end of the D3 stage, M_{E3} corresponding to E3 is released; at this time, M_{sc}=M_{E1}+M_{E2}. Similarly, the memory occupied by M_{sc} is not fully released until the end of the E1 stage. The upper scatter plot in FIG. 11B demonstrates changes over time of the memory of the skip connections of the typical U-Net described above, and the lower scatter plot in FIG. 11B demonstrates changes over time of the memory of the skip connections after the present disclosure is applied.

In order to solve the problem of storage space overhead caused by the skip connections, a Tailor algorithm proposes removing the skip connections from a residual neural network structure. Specifically, in a process of fine-tuning network parameters, one skip connection structure is removed after every predefined number of training iterations. The updated neural network fine-tunes its parameters using a knowledge distillation learning method. In the knowledge distillation learning method, a teacher neural network is a neural network with no skip connection structures removed, and serves as the teacher network. A neural network model with reduced memory overhead is obtained after a predefined number of the skip connections are removed.

Similarly, based on a method of re-parameterization, FMEN proposes merging equivalently the skip connections of the residual neural network into its parallel convolution operation during the neural network inference, and retaining the skip connections during the neural network training.

As described in the description of the prior art, the above method is applicable for reducing the memory space of the skip connections in the residual neural network model.

However, the number of the skip connections in the U-Net neural network model is much smaller than that in the residual neural network structure. Even if the skip connections are removed progressively, it will cause a significant degradation in the performance of the model. The is because in the U-Net neural network model, there is a large difference between data distribution of the feature maps generated in the encoding stage and data distribution of the feature maps generated in the decoding stage. Removing the skip connections will obviously change the data distribution in the decoding stage, thereby affecting the performance of the model. Even after fine-tuning of neural network parameters, it is difficult to restore the performance.

Meanwhile, in the U-Net neural network model, the model structure parallel to the skip connections is a nonlinear structure, and cannot be merged equivalently of the skip connections. Therefore, in the model inference stage, the skip connections will still exist, and consume a large amount of storage space.

Therefore, the existing two solutions are not applicable for reducing the storage space overhead caused by the skip connections in the U-Net neural network model during the hardware deployment.

### SUMMARY

The present disclosure provides a method for generating a neural network capable of reducing the substantial storage space overhead of the U-Net neural network model during the hardware deployment, while improving the performance of the network model as much as possible.

According to one aspect of the present disclosure, there is provided a method of generating a neural network model, characterized in that, the method comprising: constructing a U-shaped neural network model or a variant thereof, wherein at least an encoding stage and a decoding stage of processing image data are included; compressing, in the encoding stage, the generated feature map to be connected to the decoding stage; and generating, in the decoding stage, an enhanced feature map from the compressed feature map.

According to another aspect of the present disclosure, there is provided an application method for a neural network model, comprising: storing the neural network model generated based on the method described above; receiving a dataset corresponding to a requirement of a task executable by the stored neural network model; and performing operations on the dataset in each layer of the stored neural network model from top to bottom, and outputting a result.

According to another aspect of the present disclosure, there is provided an application apparatus for a neural network model, comprising: a storage module configured to store the neural network model generated based on the method described above; a receiving module configured to receive a dataset corresponding to a requirement of a task executable by the stored neural network model; and a processing module configured to perform operations on the dataset in each layer of the stored neural network model from top to bottom, and output a result.

According to another aspect of the present disclosure, there is provided a non-transitory computer-readable storage medium storing instructions which, when executed by a computer, cause the computer to perform the method of generating the neural network model described above.

Other features of the present disclosure will become apparent from the following description of the exemplary embodiments with reference to the attached drawings.

### BRIEF DESCRIPTION OF THE DRAWINGS

The drawings, which are incorporated in and constitute part of the description, illustrate exemplary embodiments of the present disclosure and serve to explain, together with the descriptions on the exemplary embodiments, the principles of the present disclosure.

FIG. 1 shows a block diagram of a hardware configuration according to an exemplary embodiment of the present disclosure.

FIGS. 2A to 9B show processing methods of a neural network model according to the first exemplary embodiment of the present disclosure.

FIG. 10 shows three ways of compressing multi-resolution feature maps into single-resolution feature maps and enhancing the single-resolution feature maps into the multi-resolution feature maps according to the present disclosure.

FIG. 11A shows a classical U-Net network structure.

FIG. 11B shows a comparison of trends of changes over time of memories occupied by the skip connections in the U-Net network between the present disclosure and the prior art.

FIG. 12 shows a schematic diagram of a training system according to the second exemplary embodiment of the present disclosure.

FIG. 13 shows a schematic diagram of a training apparatus according to the third exemplary embodiment of the present disclosure.

### DETAILED DESCRIPTION

Exemplary embodiments of the present disclosure will be described hereinafter with reference to the drawings. For the purpose of being clear and concise, not all of the features of the embodiments are described in the description. However, it should be appreciated that it is necessary to make numerous configurations specific to respective embodiments in implementation of the embodiments, so as to realize the specific target of the developing personnel. For example, restrictions associated with device and business may be satisfied; and the restrictions may vary according to different embodiments. In addition, it should be appreciated that although the development work may be very complicated and time consuming, such development work is merely routine task for a person skilled in the art benefited from the contents of the present disclosure.

It should also be noted herein that in order not to obscure the description of the present disclosure with unnecessary details, the accompanying drawings only show the processing steps and/or system structures of close concern at least according to the solution of the present disclosure; other details less associated with the present disclosure are omitted.

### (Hardware Configuration)

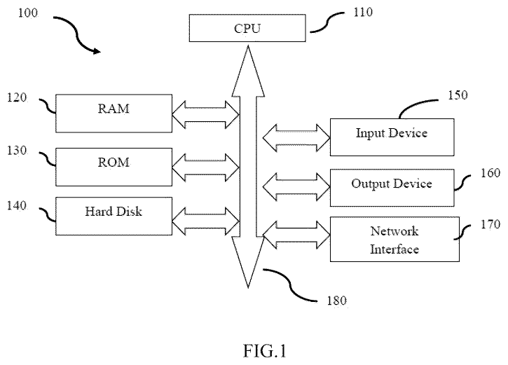

First, hardware configuration capable of implementing the techniques described below is described with reference to FIG. 1.

The hardware configuration 100 includes, for example, a Central Processing Unit (CPU) 110, a Random Access Memory (RAM) 120, a Read-Only Memory (ROM) 130, a hard disk 140, an input device 150, an output device 160, a network interface 170, and a system bus 180. In an implementation, the hardware configuration 100 is implementable by a computer, such as a tablet computer, a laptop computer, a desktop computer, or other suitable electronic devices.

In an implementation, the apparatus for training a neural network model according to the present disclosure is constructed by hardware or firmware and serves as a module or component of the hardware configuration 100. In another implementation, the method for training a neural network model according to the present disclosure is constructed by software stored in the ROM 130 or the hard disk 140 and executed by the CPU 110.

The CPU 110 is any suitable programmable control device (e.g., processor) and may execute various functions described below by executing various applications stored in the ROM 130 or the hard disk 140 (e.g., memory). The RAM 120 is used to temporarily store program or data loaded from the ROM 130 or the hard disk 140 and also used as a space for the CPU 110 to execute various processes and other available functions. The hard disk 140 stores a variety of information such as an Operating System (OS), various applications, a control program, a sample image, a trained neural network model, and predefined data (e.g., thresholds THs).

In an implementation, the input device 150 is configured to enable a user to interact with the hardware configuration 100. In an example, the user may input a sample image and a label of the sample image (e.g., region information of an object, category information of an object, etc.) via the input device 150. In a further instance, the user may trigger a corresponding process of the present disclosure via the input device 150. In addition, the input device 150 may take a variety of forms, such as a button, a keyboard, or a touch panel.

In an implementation, the output device 160 is configured to store a final trained neural network model into, for example, the hard disk 140 or to output the final generated neural network model to subsequent image processing such as object detection, object classification, image segmentation.

The network interface 170 provides an interface for connecting the hardware configuration 100 to the network. For example, the hardware configuration 100 may perform data communication via the network interface 170 with other electronic devices connected via the network. Optionally, a wireless interface may be provided for the hardware configuration 100 for wireless data communication. The system bus 180 may provide a data transmission path for mutual data transmission among the CPU 110, the RAM 120, the ROM 130, the hard disk 140, the input device 150, the output device 160, the network interface 170, and the like. Although referred to as a bus, the system bus 180 is not limited to any specific data transmission technique.

The above-mentioned hardware configuration 100 is merely illustrative; it is not intended to limit the present disclosure or the application or use thereof. In addition, for the sake of conciseness, FIG. 1 shows only one hardware configuration. Nonetheless, multiple hardware configurations may be utilized as needed. Moreover, multiple hardware configurations may be connected via a network. In that case, the multiple hardware configurations may be implemented, for example, by a computer (e.g., cloud server) or by an embedded device, such as a camera, a video camera, a Personal Digital Assistant (PDA) or other suitable electronic devices.

Next, various aspects of the present disclosure are described.

### First Exemplary Embodiment

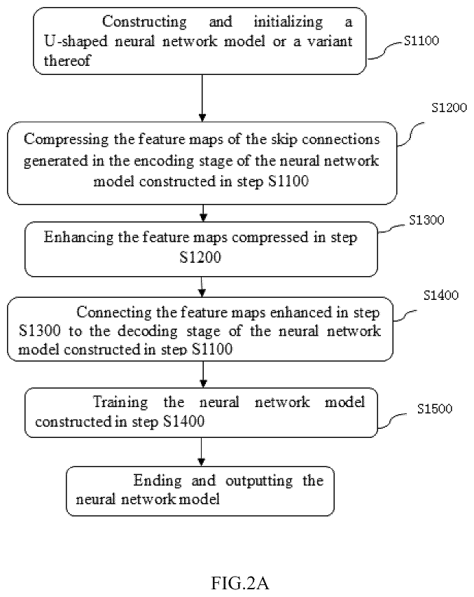

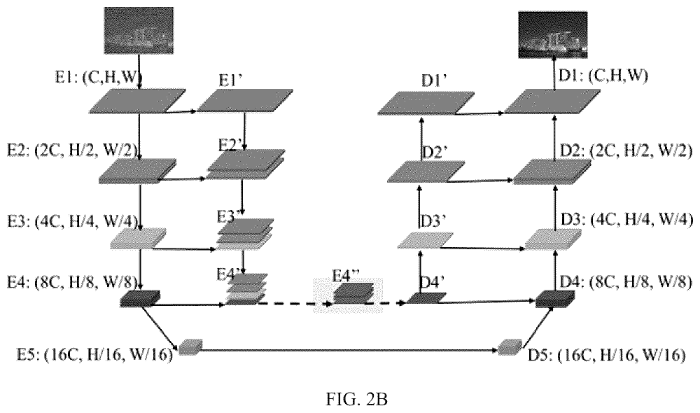

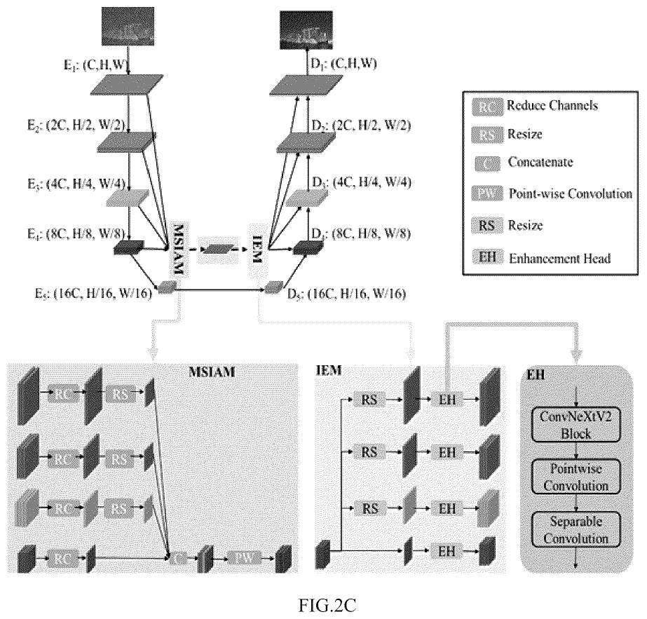

A method for generating a neural network model according to the first exemplary embodiment of the present disclosure will be described hereinafter with reference to FIGS. 2A to 8B. FIG. 2B shows a processing of stepwise compressing and generating a network structure model for an enhanced feature map, FIG. 2C shows a network structure according to this exemplary embodiment, and the processing method is specifically described in FIG. 2A.
Step S1100: constructing and initializing a U-shaped neural network model or a variant thereof.

In this step, the constructed U-shaped neural network model or the variant thereof needs to include an encoding stage, a decoding stage, and skip connection structures connecting the encoding stage and the decoding stage. The parameters of the constructed U-shaped neural network model or its variant neural network model are initialized.

The neural network model applicable to the present disclosure may be any known model, for example, a convolutional neural network model, a recurrent neural network model, a graph neural network model, etc. The present disclosure does not limit the type of the network model.

The computational precision of the neural network model applicable to the present disclosure may be any precision, either high precision or low precision. The term “high precision” and the term “low precision” refer to the relative levels of the precision and are not limited to the specific numerical values. For example, the high precision may be 32-bit floating-point type, and the low precision may be 1-bit fixed-point type. Of course, other precisions such as 16-bit, 8-bit, 4-bit, 2-bit precisions are also included in the scope of computational precision applicable to the solution of the present disclosure. The term “computational precision” may refer to precision of the weight in the neural network model or precision of the input x to be trained, which is not limited in the present disclosure. The neural network models according to the present disclosure may be Binary Neural Networks (BNNs) models, and are of course not limited to the neural network models with the other computational precisions.
Step S1200: compressing the feature maps of the skip connections generated in the encoding stage of the neural network model constructed in S1100.

In this step, the multi-resolution feature maps of the skip connections generated in the encoding stage are compressed stepwise and fused into the single-resolution feature maps, wherein the method for fusing is to fuse the feature maps of adjacent stages stepwise. As shown in FIG. 2B, on the left are the feature maps E1, E2, E3, and E4 generated in the encoding stage. On the right are the feature maps D1, D2, D3, and D4 generated in the decoding stage. E1 and E2 are first compressed in channels to obtain E1′ and E2′. The resolution of E1′ after being compressed in channels is then downsampled to the resolution of E2′, and is fused with the compressed feature map E2′. The methods for feature map fusion include channel-wise merging, addition of values of the feature maps at corresponding positions, multiplication of values the feature maps at corresponding positions, convolution operations, and the like.
Step S1300: enhancing the feature maps compressed in step S1200.

In this step, the compressed feature maps are enhanced stepwise. The number of channels and resolutions of the enhanced feature maps and the feature maps before compression are the same. As shown in FIG. 2B, D4′ is obtained by enhancing the compressed feature map E4″, D3′ is obtained based on the feature map generated when D4′ is enhanced, D2′ is obtained based on the feature map generated when D3′ is enhanced, and D1′ is obtained based on the feature map generated when D2′ is enhanced. The operations of enhancing the feature maps include an upsampling operation, a downsampling operation, a convolution operation, and the like.
Step S1400: fusing the feature maps enhanced in step S1300 into the feature maps generated in the decoding stage of the neural network model constructed in step S1100.

As shown in FIG. 2B, the enhanced feature maps and the feature maps generated in the decoding stage are fused. D4′ and D4 are fused, D3′ and D3 are fused, D2′ and D2 are fused, and D1′ and D1 are fused.
Step S1500: training the neural network model constructed in step S1400.

In this step, the neural network model constructed in step S1400 is trained based on a specific task (e.g., tasks such as image classification and instance segmentation) requirement and a training set data, until the network converges or the exit condition is satisfied.

Training of a neural network model is a cyclic and repetitive process. Each iteration involves three processes: forward calculation, backward calculation, and parameter update. Among them, forward calculation is to input a batch of data to be trained into the network, perform calculations layer by layer from top to bottom in the network model, and obtain the result of the network output. Backward calculation is a process of calculating a loss function based on the true value of the trained batch of data and the result of the network output, and passing the gradient of the loss function forward from the last layer of the network. Parameter update is mainly to calculate the updated value of the current parameter based on the back-propagated gradient value and the corresponding optimization algorithm. The neural network model is trained in this step until the network converges or the exit condition is satisfied.

In a case that the difference between the actual output result and the desired output result of the neural network model does not exceed a predetermined threshold, this indicates that weights in the neural network model are optimal solutions, and the performance of the trained neural network model has reached the desired performance. Training of the neural network model is therefore completed. Otherwise, in a case that the difference between the actual output result and the desired output result of the neural network model exceeds the predetermined threshold, it is necessary to continue the back propagation process, that is, to perform calculations layer by layer from bottom to top in the neural network model based on the difference between the actual output result and the desired output result so as to update the weights in the model, such that the performance of the network model with the weights updated is closer to the desired performance.

According to the present exemplary embodiment, first, a U-Net model or a U-Net variant model is initialized. The network model includes at least an encoding structure, a decoding structure, and the skip connections located between the encoding structure and the decoding structure.

Then, a compressing module is provided to compress and fuse feature maps generated in the encoding stage and to be passed to the decoding stage into feature maps with reduced storage space. The compressing and fusing feature maps may be fusing, either stepwise or individually, the encoded feature maps with different resolutions into single-resolution feature maps with smaller memory consumption or a group of feature maps with multiple resolutions.

An enhancing module is provided to enhance the compressed feature maps or the group of feature maps to the original multi-scale feature maps. The compressed feature maps with single-resolution is enhanced, either stepwise or individually, into a plurality of groups of feature maps with different resolutions, or channels of the multi-resolution compressed feature maps are increased.

Finally, the enhanced feature maps are fused with the corresponding-scale feature maps generated in the decoding stage, thereby generating an efficient U-shaped neural network model.

Table 1 shows a comparison of technical effects in PSNR and SSIM by taking an image deblurring task as an example according to the method of the present exemplary embodiment and the prior art. Using this solution, the system achieves the following practical effects.

TABLE 1

| Models | PSNR | SSIM |
|---|---|---|
| Baseline (U-Net) | 32.846 | 0.9604 |
| Tailor | 32.5219 | 0.9577 |
| Method of Present embodiment | 33.0437 | 0.9619 |

Table 2 shows a comparison of technical effects in PSNR and SSIM by taking an image noise reduction task as an example according to the method of the present exemplary embodiment and the prior art. Using this solution, the system achieves the following practical effects.

TABLE 2

| Models | PSNR | SSIM |
|---|---|---|
| Baseline(U-Net) | 39.9711 | 0.9599 |
| Baseline(U-Net)/without skip connection | 39.6062 | 0.9568 |
| Method of Present embodiment | 39.9729 | 0.9599 |

Compared with the prior art, the method of the present disclosure has the following advantages.

The method according to an exemplary embodiment of the present disclosure can reduce the substantial storage space overhead of the U-Net neural network model during hardware deployment, and improve the model accuracy.

### Modification 1

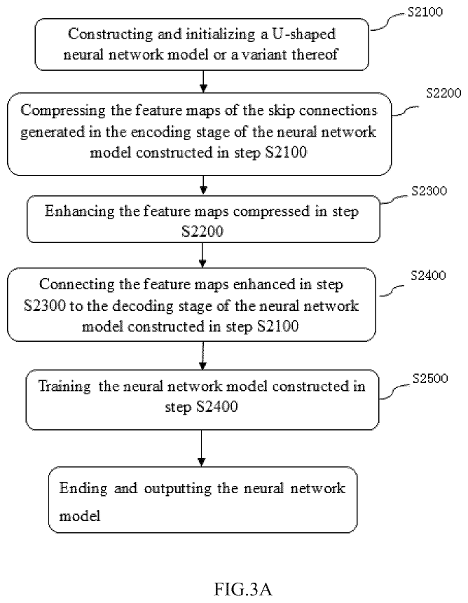

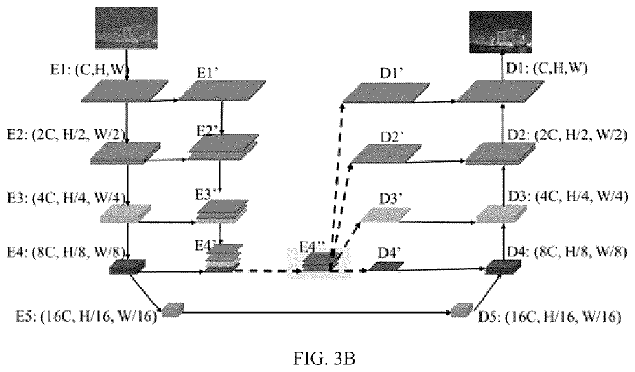

This exemplary embodiment describes a workflow of a method for generating an efficient U-shaped neural network in accordance with various aspects of the present disclosure. FIG. 3B shows a processing of compressing stepwise and enhancing independently a network structure model for the feature maps, and the processing method is specifically described in FIG. 3A.
Step S2100: similarly to step S1100, constructing and initializing a U-shaped neural network model or a variant thereof.
Step S2200: compressing the feature maps of the skip connections generated in the encoding stage of the neural network model constructed in S2100.

In this step, the multi-resolution feature maps of the skip connections generated in the encoding stage are compressed stepwise and fused into the single-resolution feature maps, wherein the method for fusing is to fuse the feature maps of adjacent stages stepwise. As shown in FIG. 3B, on the left are the feature maps E1, E2, E3, and E4 generated in the encoding stage. On the right are the feature maps D1, D2, D3, and D4 generated in the decoding stage. E1 and E2 are first compressed in channels to obtain E1′ and E2′. The resolution of E1′ after being compressed in channels is then downsampled to the resolution of E2′, and is fused with the compressed feature map E2′. The methods for feature map fusion include channel-wise merging, addition of values of the feature maps at corresponding positions, multiplication of values the feature maps at corresponding positions, convolution operations, and the like.
Step S2300: enhancing the feature maps compressed in step S2200.

In this step, the compressed feature maps of each of the resolutions are independently enhanced. The number of channels and resolutions of the enhanced feature maps and the feature maps before compression are the same. As shown in FIG. 3B, D4′ is obtained by enhancing the compressed feature map E4″, D3′ is obtained by enhancing the compressed feature map E4″, D2′ is obtained by enhancing the compressed feature map E4″, and D1′ is obtained by enhancing the compressed feature map E4″. The operations of enhancing the feature maps include an upsampling operation, a downsampling operation, a convolution operation, and the like.
Step S2400: similarly to step S1400, fusing the feature maps enhanced in step S2300 into the feature maps generated in the decoding stage of the neural network model constructed in step S2100.
Step S2500: similarly to step S1500, training the neural network model constructed in step S2400.

### Modification 2

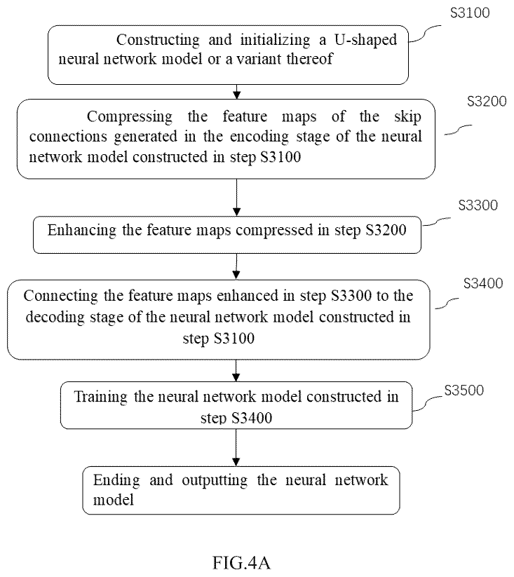

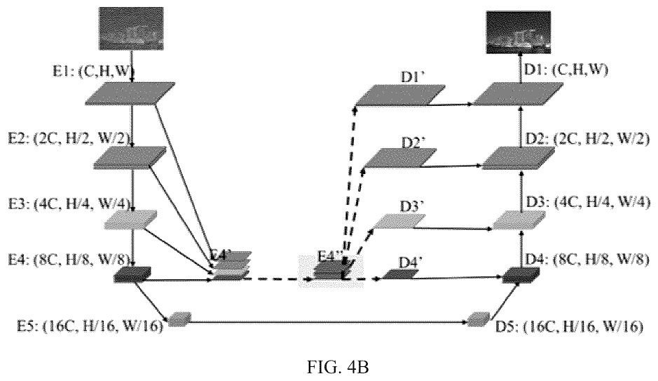

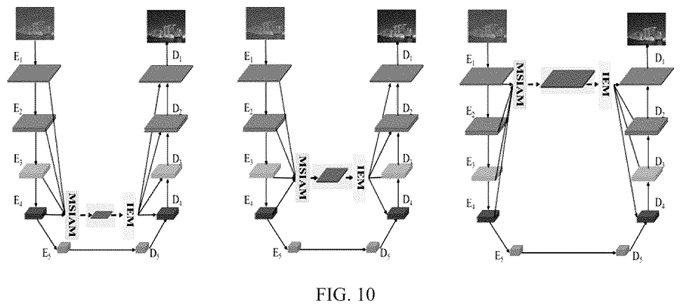

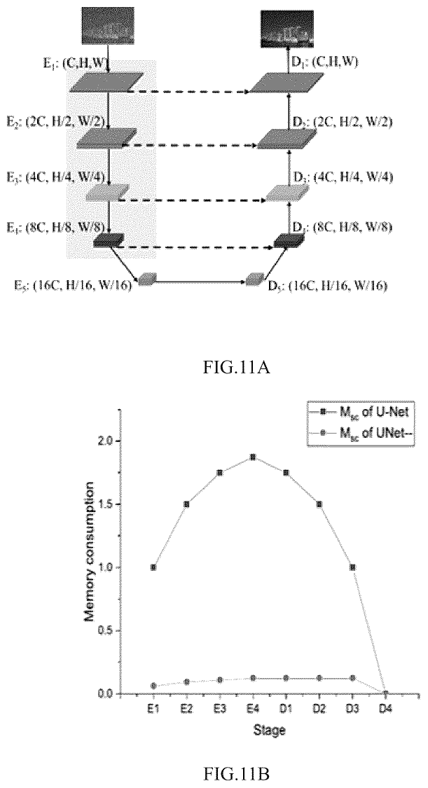

This exemplary embodiment describes a workflow of a method for generating an efficient U-shaped neural network in accordance with various aspects of the present disclosure. FIG. 4B shows a processing of compressing independently and enhancing independently a network structure model for the feature maps, and the processing method is specifically described in FIG. 4A.
Step S3100: similarly to step S1100, constructing and initializing a U-shaped neural network model or a variant thereof.
Step S3200: compressing the feature maps of the skip connections generated in the encoding stage of the neural network model constructed in step S3100. As shown in FIG. 10, the direction of feature map compression and fusion may include a sequential compression and fusion from a maximum resolution feature map to a minimum resolution feature map, a sequential fusion from the minimum resolution feature map to the maximum resolution feature map, or may include a fusion from the maximum resolution feature map and the minimum resolution feature map respectively to an intermediate resolution feature map. FIG. 10 shows three ways of compressing the multi-resolution feature maps into the single-resolution feature maps and enhancing the single-resolution feature maps into the multi-resolution feature maps according to the present disclosure. Here, the single-resolution feature maps may be feature maps having the maximum resolution or the minimum resolution, or may be feature maps having a resolution between the maximum resolution and the minimum resolution.

In this step, the multi-resolution feature maps of the skip connections generated in the encoding stage are compressed independently and fused into the single-resolution feature maps, wherein the method for fusing is to fuse all the compressed feature maps simultaneously, as shown in Equation 1.

$$E = P WConv ( [ R S ( R C ( {E}_{1} ) ) ‖ RS ( RC ( {E}_{2} ) ) ‖ … ‖ ( RC ( {E}_{n} ) ) ] ) \qquad ( 1 )$$

wherein, E is the compressed and fused single-resolution feature map, Eₙ is the original feature map generated in the nth stage of the encoding process, RC is the operation of reducing the channel, RS is the operation of changing the resolution, by which Eₙ of different resolutions uniformly transform the resolution to the target size, | is the merging operation by channel dimension, and PWConv is the convolution operation with a filter kernel size of 1.

As shown in FIG. 4B, on the left are the feature maps E1, E2, E3, and E4 generated in the encoding stage. On the right are the feature maps D1, D2, D3, and D4 generated in the decoding stage. E1, E2, E3, and E4 are first compressed in channels to obtain E1′, E2′, E3′, and E4′. The resolutions of E1′, E2′, and E3′ after being compressed in channels are then downsampled to the resolution of E4′, and are fused with the compressed feature map E4′. The methods for feature map fusion include channel-wise merging, addition of values of the feature maps at corresponding positions, multiplication of values the feature maps at corresponding positions, convolution operations, and the like.
Step S3300: enhancing the feature maps compressed in step S3200.

In this step, the compressed feature maps of each of the resolutions are independently enhanced. The number of channels and resolutions of the enhanced feature maps and the feature maps before compression are the same. As shown in FIG. 4B, D4′ is obtained by enhancing the compressed feature map E4″, D3′ is obtained by enhancing the compressed feature map E4″, D2′ is obtained by enhancing the compressed feature map E4″, and D1′ is obtained by enhancing the compressed feature map E4″. The operations of enhancing the feature maps include an upsampling operation, a downsampling operation, a convolution operation, and the like.
Step S3400: similarly to step S1400, fusing the feature maps enhanced in step S3300 into the feature map generated in the decoding stage of the neural network model constructed in step S3100.
Step S3500: similarly to step S1500, training the neural network model constructed in step S3400.

### Modification 3

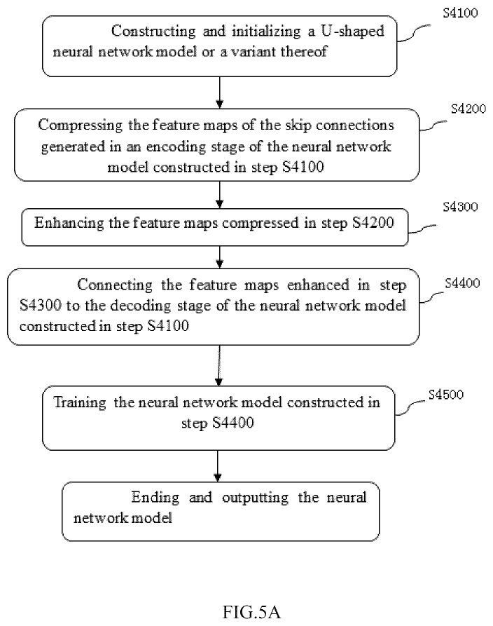

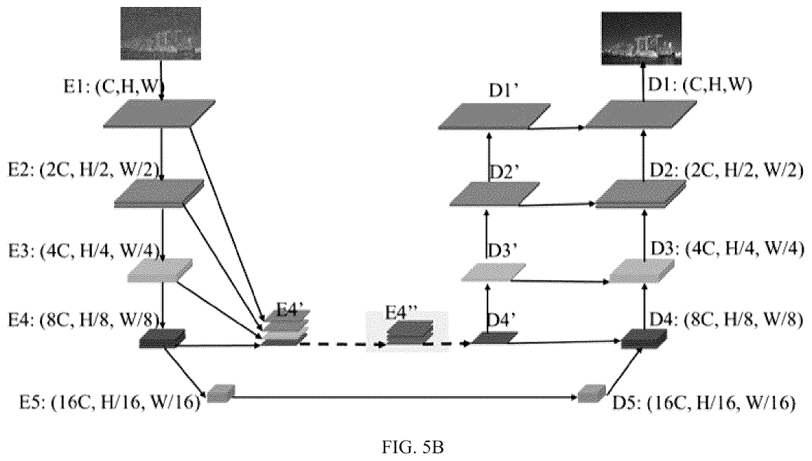

This exemplary embodiment describes a workflow of a method for generating an efficient U-shaped neural network in accordance with various aspects of the present disclosure. FIG. 5B shows a processing of compressing independently and enhancing stepwise a network structure model for the feature maps, and the processing method is specifically described in FIG. 5A.
Step S4100: similarly to step S1100, constructing and initializing a U-shaped neural network model or a variant thereof.
Step S4200: compressing the feature maps of the skip connections generated in the encoding stage of the neural network model constructed in step S4100.

In this step, the multi-resolution feature maps of the skip connections generated in the encoding stage are compressed independently and fused into the single-resolution feature maps, wherein the method for fusing is to fuse all the compressed feature maps simultaneously. As shown in FIG. 5B, on the left are the feature maps E1, E2, E3, and E4 generated in the encoding stage. On the right are the feature maps D1, D2, D3, and D4 generated in the decoding stage. E1, E2, E3, and E4 are first compressed in channels to obtain E1′, E2′, E3′, and E4′. The resolutions of E1′, E2′, and E3′ after being compressed in channels are then downsampled to the resolution of E4′, and are fused with the compressed feature map E4′. The methods for feature map fusion include channel-wise merging, addition of values of the feature maps at corresponding positions, multiplication of values the feature maps at corresponding positions, convolution operations, and the like.
Step S4300: enhancing the feature maps compressed in step S4200.

In this step, the compressed feature maps are enhanced stepwise. The number of channels and resolutions of the enhanced feature maps and the feature maps before compression are the same. As shown in FIG. 5B, D4′ is obtained by enhancing the compressed feature map E4″, D3′ is obtained by enhancing the feature map generated when D4′ is enhanced, D2′ is obtained by enhancing the feature map generated when D3′ is enhanced, and D′ is obtained by enhancing the feature map generated when D2′ is enhanced. The operations of enhancing the feature maps include an upsampling operation, a downsampling operation, a convolution operation, and the like.
Step S4400: similarly to step S1400, fusing the feature maps enhanced in step S4300 into the feature maps generated in the decoding stage of the neural network model constructed in step S4100.
Step S4500: similarly to step S1500, training the neural network model constructed in step S4400.

### Modification 4

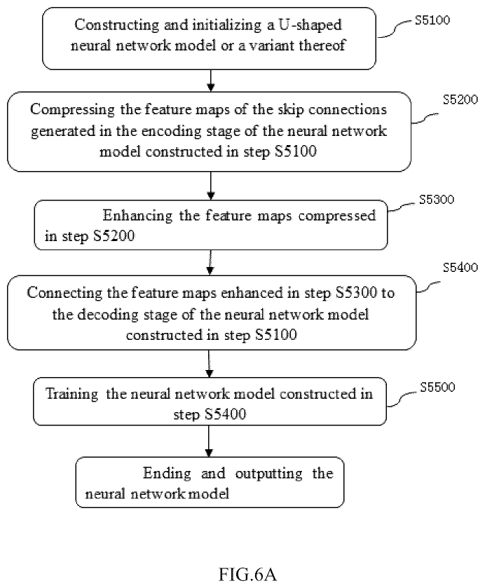

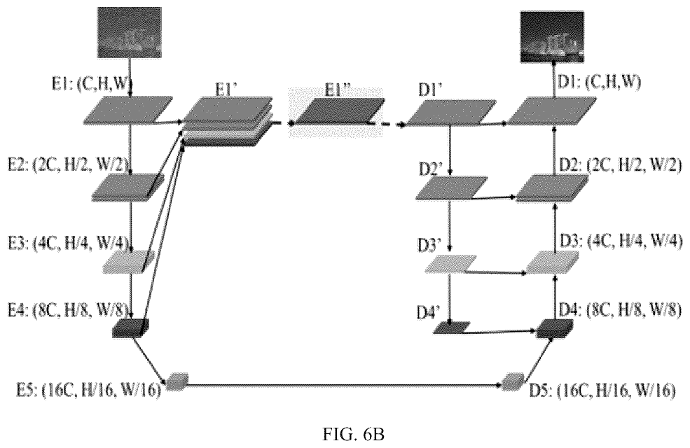

This exemplary embodiment describes a workflow of a method for generating an efficient U-shaped neural network in accordance with various aspects of the present disclosure. FIG. 6B shows a processing of compressing independently and enhancing stepwise a network structure model for the feature maps, and the processing method is specifically described in FIG. 6A.
Step S5100: similarly to step S1100, constructing and initializing a U-shaped neural network model or a variant thereof.
Step S5200: compressing the feature maps of the skip connections generated in the encoding stage of the neural network model constructed in step S5100.

In this step, the multi-resolution feature maps of the skip connections generated in the encoding stage are independently compressed and fused into the single-resolution feature maps, wherein the method for fusing is to fuse all the compressed feature maps simultaneously. As shown in FIG. 6B, on the left are the feature maps E1, E2, E3, and E4 generated in the encoding stage. On the right are the feature maps D1, D2, D3, and D4 generated in the decoding stage. E1, E2, E3, and E4 are first compressed in channels to obtain E1′, E2′, E3′, and E4′. The resolutions of E2′, E3′ and E4′ after being compressed in channels are then upsampled, increasing to the resolution of E1′, and are fused with the compressed feature map E1′. The methods for feature map fusion include channel-wise merging, addition of values of the feature maps at corresponding positions, multiplication of values the feature maps at corresponding positions, convolution operations, and the like.
Step S5300: enhancing the feature maps compressed in step S5200.

In this step, the compressed feature maps are enhanced stepwise. The number of channels and resolutions of the enhanced feature maps and the feature maps before compression are the same. As shown in FIG. 6B, D1′ is obtained by enhancing the compressed feature map E1″, D2′ is obtained by enhancing the feature map generated when D1′ is enhanced, D3′ is obtained by enhancing the feature map generated when D2′ is enhanced, and D4′ is obtained by enhancing the feature map generated when D3′ is enhanced. The operations of enhancing the feature maps include an upsampling operation, a downsampling operation, a convolution operation, and the like.
Step S5400: similarly to step S1400, fusing the feature maps enhanced in step S5300 into the feature maps generated in the decoding stage of the neural network model constructed in step S5100.
Step S5500: similarly to step S1500, training the neural network model constructed in step S5400.

### Modification 5

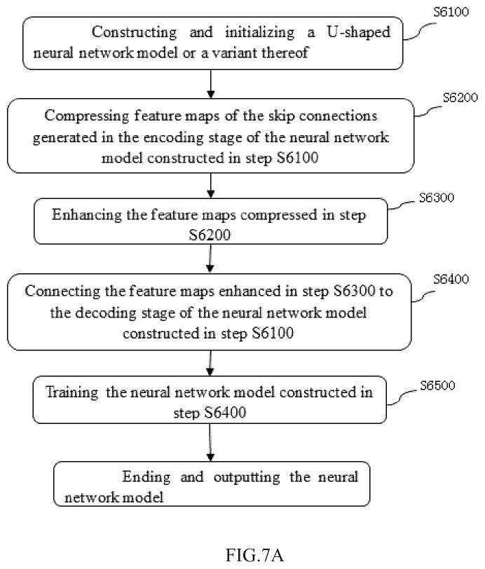

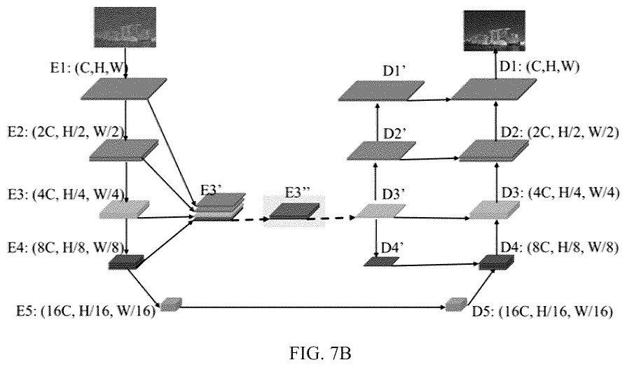

This exemplary embodiment describes a workflow of a method for generating an efficient U-shaped neural network in accordance with various aspects of the present disclosure. FIG. 7B shows a processing of compressing independently and enhancing stepwise a network structure model for the feature maps, and the processing method is specifically described in FIG. 7A.
Step S6100: similarly to step S1100, constructing and initializing a U-shaped neural network model or a variant thereof.
Step S6200: compressing the feature maps of the skip connections generated in the encoding stage of the neural network model constructed in step S6100.

In this step, the multi-resolution feature maps of the skip connections generated in the encoding stage are compressed independently and fused into the single-resolution feature maps, wherein the method for fusing is to fuse all the compressed feature maps simultaneously. As shown in FIG. 7B, on the left are the feature maps E1, E2, E3, and E4 generated in the encoding stage. On the right are the feature maps D1, D2, D3, and D4 generated in the decoding stage. E1, E2, E3, and E4 are first compressed in channels to obtain E1′, E2′, E3′, and E4′. The resolutions of E1′ and E2′ after being compressed in channels are then downsampled to the resolution of E3′, while the resolution of E4′ is upsampled to the resolution of E3′, and is fused with the compressed feature map E3′. The methods for feature map fusion include channel-wise merging, addition of values of the feature maps at corresponding positions, multiplication of values the feature maps at corresponding positions, convolution operations, and the like.
Step S6300: enhancing the feature maps compressed in step S6200.

In this step, the compressed feature maps are enhanced stepwise. The number of channels and resolutions of the enhanced feature maps and the feature maps before compression are the same. As shown in FIG. 7B, D3′ is obtained by enhancing the compressed feature map E3″, D2′ is obtained by enhancing the feature map generated when D3′ is enhanced, D1′ is obtained by enhancing the feature map generated when D2′ is enhanced, and D4′ is obtained by enhancing the feature map generated when D3′ is enhanced. The operations of enhancing the feature maps include an upsampling operation, a downsampling operation, a convolution operation, and the like.
Step S6400: similarly to step S1400, fusing the feature maps enhanced in step S6300 into the feature maps generated in the decoding stage of the neural network model constructed in step S6100.
Step S6500: similarly to step S1500, training the neural network model constructed in step S6400.

### Modification 6

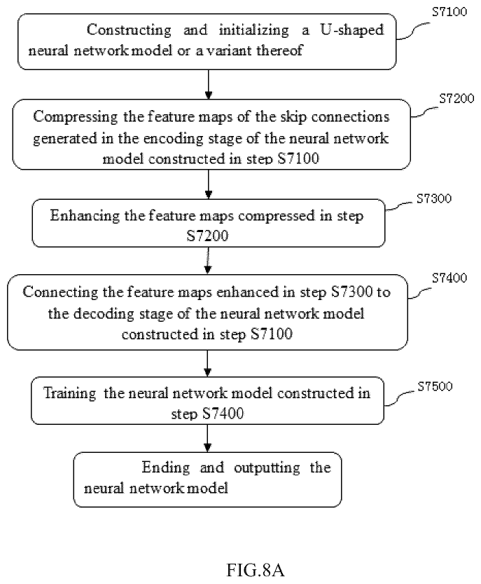

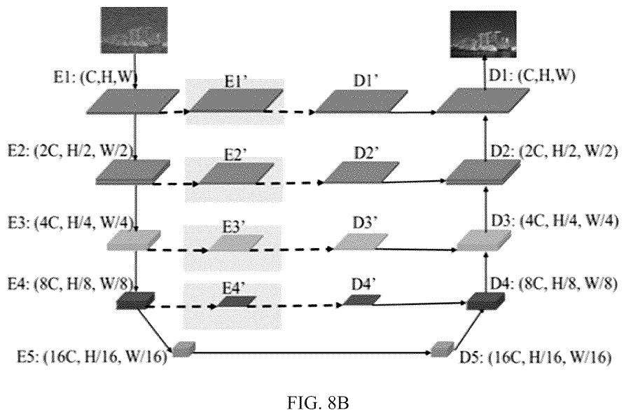

This exemplary embodiment describes a workflow of a method for generating an efficient U-shaped neural network in accordance with various aspects of the present disclosure. FIG. 8B shows a processing of compressing independently and enhancing independently a network structure model for the feature maps, and the processing method is specifically described in FIG. 8A.
Step S7100: similarly to step S1100, constructing and initializing a U-shaped neural network model or a variant thereof.
Step S7200: compressing the feature maps of the skip connections generated in the encoding stage of the neural network model constructed in step S7100.

In this step, the multi-resolution feature maps of the skip connections generated in the encoding stage are independently compressed into the multi-resolution feature maps. As shown in FIG. 8B, on the left are the feature maps E1, E2, E3, and E4 generated in the encoding stage. On the right are the feature maps D1, D2, D3, and D4 generated in the decoding stage. Each of E1, E2, E3, and E4 is compressed in channels, while the resolutions remain unchanged.
Step S7300: enhancing the feature maps compressed in step S7200.

In this step, the compressed multi-resolution feature maps are enhanced to the multi-resolution feature maps. The number of channels and resolutions of the enhanced feature maps and the feature maps before compression are the same. As shown in FIG. 8B, D1′ is obtained by enhancing the compressed feature map E1′, D2′ is obtained by enhancing the compressed feature map E2′, D3′ is obtained by enhancing the compressed feature map E3′, and D4′ is obtained by enhancing the compressed feature map E4′. The operations of enhancing the feature maps include an upsampling operation, a downsampling operation, a convolution operation, and the like.
Step S7400: similarly to step S1400, fusing the feature maps enhanced in step S7300 into the feature maps generated in the decoding stage of the neural network model constructed in step S7100.
Step S7500: similarly to step S1500, training the neural network model constructed in step S7400.

### Modification 7

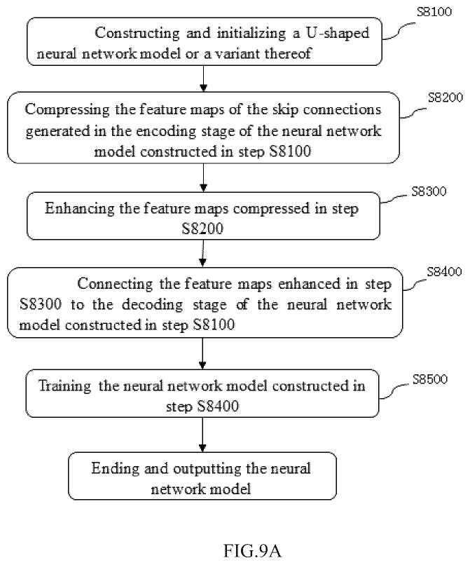

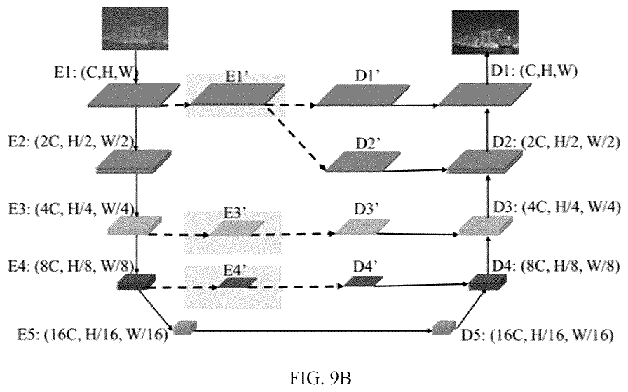

This exemplary embodiment describes a workflow of a method for generating an efficient U-shaped neural network in accordance with various aspects of the present disclosure. FIG. 9B shows a processing of compressing independently and enhancing independently a network structure model for the feature maps, and the processing method is specifically described in FIG. 9A.
Step S8100: similarly to step S1100, constructing and initializing a U-shaped neural network model or a variant thereof.
Step S8200: compressing the feature maps of the skip connections generated in the encoding stage of the neural network model constructed in step S8100.

In this step, the multi-resolution feature maps of the skip connections generated in the encoding stage are independently compressed into the multi-resolution feature maps. As shown in FIG. 9B, on the left are the feature maps E1, E2, E3, and E4 generated in the encoding stage. On the right are the feature maps D1, D2, D3, and D4 generated in the decoding stage. Each of E1, E3, and E4 is compressed in channels, while the resolutions remain unchanged. Here, E2 generated in the encoding stage is ignored.
Step S7300: enhancing the feature maps compressed in step S8200.

In this step, the compressed multi-resolution feature maps E3′ and E4′ are enhanced into the multi-resolution feature maps D3′ and D4′, and the number of channels and resolution of the enhanced feature maps and the feature maps before compression are the same. The compressed single-resolution feature map E1′ is enhanced to the multi-resolution feature maps D1′ and D2′, with D1′ and E1, and D2′ and E2 having the same number of channels and resolutions. As shown in FIG. 9B, D1′ is obtained by enhancing the compressed feature map E1′, D2′ is obtained by enhancing the compressed feature map E1′, D3′ is obtained by enhancing the compressed feature map E3′, and D4′ is obtained by enhancing the compressed feature map E4′. The operations of enhancing the feature maps include an upsampling operation, a downsampling operation, a convolution operation, and the like.
Step S8400: similarly to step S1400, fusing the feature maps enhanced in step S8300 into the feature maps generated in the decoding stage of the neural network model constructed in step S8100.
Step S8500: similarly to step S1500, training the neural network model constructed in step S8400.

In this embodiment, only a part of the feature maps generated in the encoding stage is used as the skip connections, while a complete enhanced feature map is generated in the decoding stage. This achieves the generation of enhanced, multi-resolution decoded feature maps from the single-resolution, compressed encoded feature maps, thereby further saving the memory of the skip connections.

### Second Exemplary Embodiment

Based on the above-described first exemplary embodiment, the second exemplary embodiment of the present disclosure describes a network model training system, including a terminal, a communication network, and a server. The terminal and the server perform communication via the communication network. The server trains a network model stored in the terminal online with a network model stored locally, such that the terminal is capable of carrying out real-time businesses using the trained network model. Various parts of the training system according to the second exemplary embodiment of the present disclosure are described below.

The terminal in the training system may be an embedded image collection device such as a security camera, and may alternatively be a device such as a smartphone, a PAD, etc. Of course, the terminal may not be a terminal such as an embedded device of relatively low computational capabilities, but is other terminals of relatively high computational capabilities. The number of the terminals in the training system may be determined based on the actual needs. For instance, if the training system is for training security cameras in a shopping mall, all security cameras in the shopping mall may be deemed as terminals. In that case, the number of the terminals in the training system is fixed. For another instance, if the training system is for training smartphones of users in the shopping mall, all smartphones accessed to the wireless local network of the shopping mall may be deemed as terminals. In that case, the number of the terminals in the training system is not fixed. The second exemplary embodiment of the present disclosure does not limit the type and the number of the terminals in the training system as long as the terminal is capable of storing and training a network model.

The server in the training system may be a high-performance server of relatively high computational capabilities, such as a cloud server. The number of the servers in the training system may be determined based on the number of terminals to be served. For example, if the number of terminals to be trained in the training system is relatively small or the geographical range in which the terminals are distributed is relatively small, the number of servers in the training system may be smaller; for example, there may be only one server. If the number of terminals to the trained in the training system is relatively large or the geographical range in which the terminals are distributed is relatively large, the number of servers in the training system may be larger; for example, a server cluster is established. The second exemplary embodiment of the present disclosure does not limit the type and the number of the servers in the training system as long as the server is capable of storing at least one network model and providing information for training the network model stored in the terminal.

The communication network in the second exemplary embodiment of the present disclosure is a wireless network or wired network realizing information transmission between the terminal and the server. All networks currently available in up/downlink transmission between network servers and terminals may be used as the communication network in this embodiment. The second exemplary embodiment of the present disclosure does not limit the type and the communication method of the communication network. Of course, the second exemplary embodiment of the present disclosure is not restricted to any other communication method. For example, a third-party storage region may be allocated to the training system. When information is to be transmitted by either of the terminal and the server to the other, the information to be transmitted is stored in the third-party storage region. The terminal and the server read information in the third-party storage region at regular times to realize information transmission therebetween.

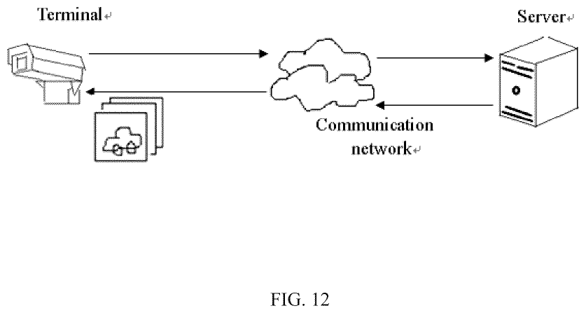

With reference to FIG. 12, the online training process of the training system according to the present exemplary embodiment of the present disclosure is described in details. FIG. 12 shows an example of the training system. The training system is assumed to include a terminal and a server. The terminal is capable of real-time photographing. It is assumed that the terminal stores a network model which can be trained and can process images, and the server stores the same network model. The training process of the training system is described below.
Step S201: the terminal initiates a training request to the server via the communication network.

The terminal initiates a training request to the server via the communication network. The request includes information such as a terminal identifier and the like. The terminal identifier is information uniquely representing the identity of the terminal (e.g., ID or IP address of the terminal and the like).

The above step S201 is explained with an example in which one terminal initiates the training request. Of course a plurality of terminals may initiate training requests in parallel. The processes of a plurality of terminals are similar to the process of one terminal, and are thus not redundantly described herein.
Step S202: the server receives the training request.

The training system shown in FIG. 12 includes only one server. Therefore, the communication network may transmit the training request initiated by the terminal to the server. If the training system includes a plurality of servers, the training request may be transmitted to a relatively idle server in view of the idleness of the servers.
Step S203: the server responds to the received training request.

The server determines the terminal initiating the request based on the terminal identifier included in the received training request, to determine the network model to be trained stored in the terminal. An option is that the server determines the network model to be trained stored in the terminal initiating the request based on a comparison table of the terminals and the network models to be trained. Another option is that the training request includes information of the network model to be trained, and the server may determine the network model to be trained based on the information. Here, determining the network model to be trained includes, but is not limited to, determining information characterizing the network model, such as a network architecture, a hyperparameter of the network model, and the like.

When the server determines the network model to be trained, the method of the first exemplary embodiment of the present disclosure may be used to train the network model stored in the terminal initiating the request using the same network model stored locally in the server. Specifically, according to the method of the first exemplary embodiment, the server updates the weights in the network model locally, and transmits the updated weights to the terminal so that the terminal synchronizes the network model to be trained stored in the terminal based on the received updated weights. Here, the network model in the server and the network model to be trained in the terminal may be the same network model; or the network model in the server may be more complicated than the network model in the terminal, but the two have close outputs. The present disclosure does not limit the type of the network model for training in the server and the network model to be trained in the terminal as long as the updated weights output from the server can make the network models in the terminal synchronized, such that the outputs by the synchronized network models in the terminal become closer to the expected output.

In the training system shown in FIG. 6B, the terminal initiates the training request actively. Optionally, the second exemplary embodiment of the present disclosure is not limited to broadcasting inquiry information by the server and then responding to the inquiry information by the terminal for the above-described training process.

By the training system according to the second exemplary embodiment of the present disclosure, the server can train the network model in the terminal online, improving the flexibility of the training while greatly improving the capability of the terminal to handle businesses and expanding business handling scenarios of the terminal. In the present exemplary embodiment, the training system is described above with online training as an example. However, the present disclosure is not limited to the offline training process, which is not redundantly described herein.

### Third Exemplary Embodiment

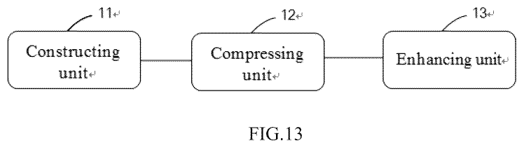

The third exemplary embodiment of the present disclosure describes a generation apparatus for a neural network model. The apparatus can execute the generation method described in the first exemplary embodiment. Moreover, when applied to an online training system, the apparatus may be an apparatus in the server described in the third exemplary embodiment. The software structure of the apparatus will be described in detail below with reference to FIG. 13.

The training apparatus in the present third exemplary embodiment includes a constructing unit 11, a compressing unit 12, and an enhancing unit 13. The constructing unit 11 constructs a U-shaped neural network model or a variant thereof in which at least an encoding stage and a decoding stage for processing image data are included; the compressing unit 12 compresses, in the encoding stage, the generated feature maps to be connected to the decoding stage; and the enhancing unit 13 generates, in the decoding stage, enhanced feature maps from compressed feature maps.

The generation apparatus of this embodiment further includes modules for realizing the functions of the server in the training system, such as the functions of identifying received data, data packaging, network communication, etc., which are not redundantly described herein.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a “non-transitory computer-readable storage medium”) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The embodiments of the present disclosure may also be implemented by a method of providing the software (program) that executes the functions of the above-mentioned embodiments to a system or device via a network or various storage media, where a computer or a Central Processing Unit (CPU) or a microprocessor unit (MPU) of this system or device reads out and executes the program.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

What is claimed is:

1. A method of generating a neural network model, the method comprising:
compressing feature maps generated in an encoding stage of a U-shaped neural network model, wherein the feature maps are connected to a decoding stage of the U-shaped neural network model via skip connections, wherein the U-shaped neural network model includes at least the encoding stage and the decoding stage for processing image data; and
generating, in the decoding stage, enhanced feature maps from compressed feature maps.

2. The method according to claim 1, wherein one or more encoded feature maps with different resolutions are generated in the encoding stage of the U-shaped neural network model, the encoded feature maps being connected to the decoding stage via the skip connections.

3. The method according to claim 1, wherein a total memory consumption of the feature maps via the skip connections after compression is less than that before compression.

4. The method according to claim 1, wherein compressing includes reducing a number of channels in the feature maps of the skip connections generated in the encoding stage.

5. The method according to claim 1, wherein compressing includes reducing resolutions of the feature maps of the skip connections generated in the encoding stage.

6. The method according to claim 1, wherein compressing includes fusing, either stepwise or individually, the feature maps of the skip connections with different resolutions generated in the encoding stage into resolution feature maps that consume less memory.

7. The method according to claim 6, wherein fusing includes fusing high-resolution feature maps into low-resolution feature maps by reducing resolution, fusing the low-resolution feature maps into the high-resolution feature maps by increasing resolution, and a combination thereof.

8. The method according to claim 1, wherein the feature maps being compressed are all the feature maps of the skip connections generated in the encoding stage.

9. The method according to claim 1, wherein the feature maps being compressed are a part of the feature maps of the skip connections generated in the encoding stage.

10. The method according to claim 1, wherein resolutions of the compressed feature maps are equal to feature maps, generated in different stages, with a maximum, a minimum, or any intermediate resolution.

11. The method according to claim 1, the feature maps of the skip connections have the same resolutions after compression and before re-generation.

12. The method according to claim 1, wherein generating enhanced feature maps includes increasing a number of channels of the compressed feature maps.

13. The method according to claim 1, wherein generating enhanced feature maps includes increasing resolutions of the compressed feature maps.

14. The method according to claim 1, wherein generating enhanced feature maps includes enhancing the compressed feature maps with a single-resolution to the feature maps with the same resolution.

15. The method according to claim 1, wherein generating enhanced feature maps comprises enhancing, either stepwise or individually, the compressed feature maps with a single-resolution to a plurality of groups of feature maps with different resolutions.

16. The method according to claim 15, wherein generating enhanced feature maps includes converting low-resolution compressed feature maps into high-resolution feature maps, converting high-resolution compressed feature maps into low-resolution feature maps, and a combination thereof.

17. The method according to claim 4, wherein compressing includes a downsampling operation, an upsampling operation, a convolution operation, an addition operation, a concatenation operation, a multiplication operation, or any other operators and algorithms that can reduce the storage requirements of feature maps.

18. The method according to claim 12, wherein generating enhanced feature maps includes a downsampling operation, an upsampling operation, a convolution operation, or any other operators and algorithms that can enhance the representation capability of feature maps.

19. A method of training a neural network model, the method comprising:
compressing feature maps generated in an encoding stage of a U-shaped neural network model, wherein the feature maps are connected to a decoding stage of the U-shaped neural network model via skip connections, wherein the U-shaped neural network model includes at least the encoding stage and the decoding stage for processing image data; and
generating, in the decoding stage, enhanced feature maps from compressed feature maps;
calculating a predicted output result based on the constructed neural network model and data obtained from a training data set; and
calculating a loss based on a loss function and the predicted output result to update parameters of a current neural network.

20. A apparatus that generates a neural network model comprising:
at least one memory storing a program; and
at least one processor that, upon execution of the program, is configured to operate as:
a compressing unit that compresses feature maps generated in an encoding stage of a U-shaped neural network model, wherein the feature maps are connected to a decoding stage of the U-shaped neural network model via skip connections, wherein the U-shaped neural network model includes at least the encoding stage and the decoding stage for processing image data; and
an enhancing unit that generates, in the decoding stage, enhanced feature maps from compressed feature maps.

21. A training apparatus for a neural network model, comprising:
at least one memory storing a program; and
at least one processor that, upon execution of the program, is configured to operate as:
a constructing unit configured to construct a neural network model generated according to the method of claim 1;
a predicting unit configured to calculate a predicted output result based on the constructed neural network model and data obtained from a training data set; and
an updating unit configured to calculate a loss based on a loss function and the predicted output result to update parameters of a current neural network.

22. An application method for a neural network model comprising:
storing a neural network model generated based on the method of claim 1;
receiving a dataset corresponding to a requirement of a task executable by the stored neural network model; and
performing operations on the dataset in each layer of the stored neural network model from top to bottom, and outputting a result.

23. An application apparatus for a neural network model comprising:
a storage module configured to store a neural network model generated based on the method of claim 1;
a receiving module configured to receive a dataset corresponding to a requirement of a task executable by the stored neural network model; and
a processing module configured to perform operations on the dataset in each layer of the stored neural network model from top to bottom, and output a result.

24. A non-transitory computer-readable storage medium storing instructions which, when executed by a computer, cause the computer to perform the method of generating a neural network model, the method comprising:
compressing feature maps generated in an encoding stage of a U-shaped neural network model, wherein the feature maps are connected to a decoding stage of the U-shaped neural network model via skip connections, wherein the U-shaped neural network model includes at least the encoding stage and the decoding stage for processing image data; and
generating, in the decoding stage, enhanced feature maps from compressed feature maps.
